(19) United States
(12) Patent Application Publication
(10) Pub. No.: US 2008/0273348 A1
(43) Pub. Date: Nov. 6, 2008

(54) Artificial Illuminated Plant Display

(75) Inventors: Teresa S. Klohn, Mound, MN (US); John Thompson, Spirit Lake, IA (US)

Correspondence Address: FISH & RICHARDSON P.C., PO BOX 1022, MINNEAPOLIS, MN, 55440-1022, US

(73) Assignee: Cameleon Products LLC, Mound, MN (US)

(21) Appl. No.: 12/106,027

(22) Filed: Apr. 18, 2008

(51) Int. Cl. A41G 1/00; F21S 4/00

(52) U.S. Cl. 362/567

(57) ABSTRACT

An electrically illuminated artificial plant display may include a plurality of individual plant sprays, each spray including optical fibers and branch members bearing light emitting diodes, the optical fibers and branch members terminating at a plug that includes a readily replaceable colored lens to filter light which is transmitted to the fiber optic members and electrical contacts for transmitting power to the diodes disposed on the branch members. The plug may be insertable into a base unit that includes a plurality of receptacles, each receptacle adapted to receive a single plug. The receptacles may each include both electrical contacts and a light emitting diode such that the lens in the plug is positioned between the base unit's light emitting diode and the ends of the fiber optic cables when the plug is in an installed position.

### BACKGROUND

Electrical lighting has been applied to a variety of ornamental plants to enhance their appearance. Strands of lights are commonly hung on trees, both artificial and real. Such light strands typically comprise incandescent lights arranged in a series. Each individual light gives off a significant amount of heat, but due to the fact that the bulb and the plant on which it is hung are exposed to air on all sides and are typically in a well ventilated environment, the bulbs and the plant do not usually reach an unsafe temperature.

Recently light emitting diodes light strings have been developed. Such light strings have the advantage that they generate less heat and thus are at least moderately more safe than incandescent light strings. Light emitting diodes have the disadvantage, however, that they typically require rectification of alternating current power supplies.

Certain artificial illuminated plant displays include light emitting diode bulbs that are connected to electrical wires that run along the branches. U.S. Pat. No. 7,108,391 discloses an artificial miniature landscape model includes a multi-colored light emitting diodes, metallic conductor branches, electrically insulated conductors, heat shrink bushings, or insulation tubular plugs, or internally or externally threaded tubular connectors, a low voltage rectifier, base connectors, molded artifacts, and pots. The light emitting diode bulbs are disposed among the flora and leaves of the artificial plant and at the base of the artificial stem there are electrical conductors that supply power to illuminate the light emitting diodes and to operate electrical devices that are disposed on the branches of the artificial branches.

US Patent Application Publication No. 2004/0085758 discloses an electric decorative flower comprises of a small light source enclosed within the artificial flower to illuminate the artificial flower from within to enhance the three-dimensional depth and aesthetic appeal of the artificial flower. The electric decorative flower comprises of an artificial flower assembled around a small light source such as a small light bulb or a light-emitting diode. After assembly of the artificial flower, the small light source will be generally enclosed in the middle of the artificial flower. The small light source may be connected to a power source through wires enclosed within the stems of the artificial flowers, hidden from view. When power is applied to the small light source, it will emit light that illuminates the flower from within to give it a soft glow.

Fiber optics have also been incorporated into lighted artificial plant displays. U.S. Pat. No. 6,918,692 describes a decorative optical fiber artificial plant has a base and an artificial foliage arrangement. The base has a housing and a colored light generator mounted in the housing. The artificial foliage arrangement is composed of multiple optical fibers and is connected to a specific position of the housing on which colored lights shines. The fibers terminate in a base structure. Within the base are disposed a plurality of light emitting diodes of different colors which provide illumination for the fibers. The fibers are connected to a microprocessor and multiple electronic switches connected between output ports of the microprocessor and the corresponding light emitting diodes. Further, different driving programs are built into the microprocessor so the colored light generator can generate different color lights with various characteristics.

U.S. Pat. No. 6,739,746 discloses an indoor/outdoor optical-fiber Christmas trees, consisting of a base unit that houses a lamp bulb on the bottom surface of the unit which projects light up through a rotating sleeve gear. The apparatus also has an upper base cover fixing unit, a water-resistant hood, a top cover and a tree unit including optical fibers to transmit the light from the lamp bulb. The rotating unit is installed on the fixing unit structure on the upper cover of the base, using a ringed wall protruding from the top periphery of the main base unit, the water-resistant hood fastened onto the top of the upper base cover, and the arched top cover covering the top of the water-resistant hood, to enable heat radiation and water resistant functions to the entire base assembly, so the Christmas tree can be installed for indoor and outdoor purposes.

The foregoing devices provide a single light emitting diode light source for all of the fiber optic elements attached to the base. In these devices replacement variance in the color in the plant arrangement is provided by either a light bulb with a rotating colored filter or an array of colored light emitting diodes driven by a programmed microcontroller. Moreover, these devices include only fiber optic illumination.

### SUMMARY

An electrically illuminated artificial plant display may include a plurality of individual plant sprays, each spray including optical fibers and branch members bearing light emitting diodes, the optical fibers and branch members terminating at a plug that includes a readily replaceable colored lens to filter light which is transmitted to the fiber optic members and electrical contacts for transmitting power to the diodes disposed on the branch members. The plug may be insertable into a base unit that includes a plurality of receptacles, each receptacle adapted to receive a single plug. The receptacles may each include both electrical contacts and a light emitting diode such that the lens in the plug is positioned between the base unit's light emitting diode and the ends of the fiber optic cables when the plug is in an installed position. The plug may seal with the base in a substantially water resistant manner and the base unit may include on its bottom surface a heat sink for evacuating heat from the light emitting diode disposed in the receptacle.

In a preferred embodiment, the lens may be readily removable from the plug such that a lenses of different colors may be selectively inserted into the plug. Each plant spray may further include an alignment means to ensure that the spray is positioned in one or more predetermined orientations relative to the base unit and a substantially waterproof seal to inhibit water intrusion into the base unit during normal exposure to outdoor weather conditions when the coupling is in an installed position relative to the base unit.

The base unit may include a top portion and a bottom portion that are sealingly mated in a substantially waterproof manner. The top portion may include a plurality of apertures to receive the couplings. The base unit may also include a plurality of receptacles positioned below respective ones of the apertures, the receptacles being configured to releasably receive the coupling and having a light emitting diode positioned at a bottom end of the receptacle such that the diode is aligned with the optical lens, the receptacle further including a vertically extending wall having at least one electrical contact that engages a cooperating electrical contact on the coupling when the coupling is in an installed position. The receptacle may be composed of a material that has low thermal conductivity and wherein the receptacle is coupled to the bottom portion by a structure having a high thermal conductivity. The bottom portion may include a substantially planar metal structure that has high thermal conductivity and further includes a plurality of fins to promote heat transfer away from the base unit. The base unit may optionally include a direct current batter power source.

An ornamental housing may be coupled to the base unit such that a substantial majority of the base unit is spaced apart from the housing, thereby forming a convection channel around the base unit that promotes heat transfer from the base unit while substantially minimizing heat transfer to the housing.

Certain embodiments may provide one or more of the following advantages. In some embodiments, the sprays may be readily interchangeable so that plant sprays of various designs or color schemes can be coupled to the base unit. In some embodiments, the artificial plant display plug members may contain readily interchangeable lens for changing the color of light transmitted to the optic strands. In some embodiments, the plant sprays may contain both fiber optic strands and colored light bulbs or light emitting diodes in the same display. In some embodiments, the plant sprays may be positioned in several different orientations with respect to the base unit. In some embodiments the artificial plant display may be substantially water resistant. In some embodiments, the base unit may include a means for efficient heat transfer away from a fiber optic light source. In some embodiments, the artificial plant display may contain substantially no visible electrical wiring. In some embodiments, the lenses may be readily removable from the plant sprays and interchangeable with other similar lenses.

### DESCRIPTION OF DRAWINGS

FIG. 1 shows an example of an artificial plant display.

FIG. 2 shows a close up view of an artificial plant display with individual plant sprays coupled to a base unit.

FIG. 3 shows an individual plant spray for use in an artificial plant display.

FIG. 4 shows a plugging end of an individual plant spray.

FIG. 5 shows the individual components that make up a plugging end of an individual plant spray.

FIG. 6 shows the main components that make up a base unit of an artificial plant display.

FIG. 7 shows the bottom portion of a base unit of an artificial plant display.

FIG. 8 shows a heat dissipation device on the bottom of a base unit of an artificial plant display.

FIG. 9 shows a base unit of an artificial plant display mounted to an ornamental housing.

FIG. 10 shows a plugging end of an individual plant spray coupled to a base unit.

FIG. 11 shows a cross section of a plugging end of an individual plant spray coupled to a receptacle in a base unit.

FIG. 12 shows an alternate embodiment of an artificial plant display.

FIG. 13 shows a close up view of an alternate embodiment of an artificial plant display.

FIG. 14 shows an alternate embodiment of an individual plant spray for use in an artificial plant display.

FIG. 15 shows a cross section of an individual plant spray coupled to a bulb unit

FIG. 16 shows an alternate embodiment of an artificial plant display in relation to a source of power.

FIG. 17 shows an alternate embodiment of an artificial plant display coupled to a power supply unit.

FIG. 18 shows the individual components that make up a power supply unit for an artificial plant display.

Like reference symbols in the various drawings indicate like elements.

### DETAILED DESCRIPTION OF ILLUSTRATIVE IMPLEMENTATIONS

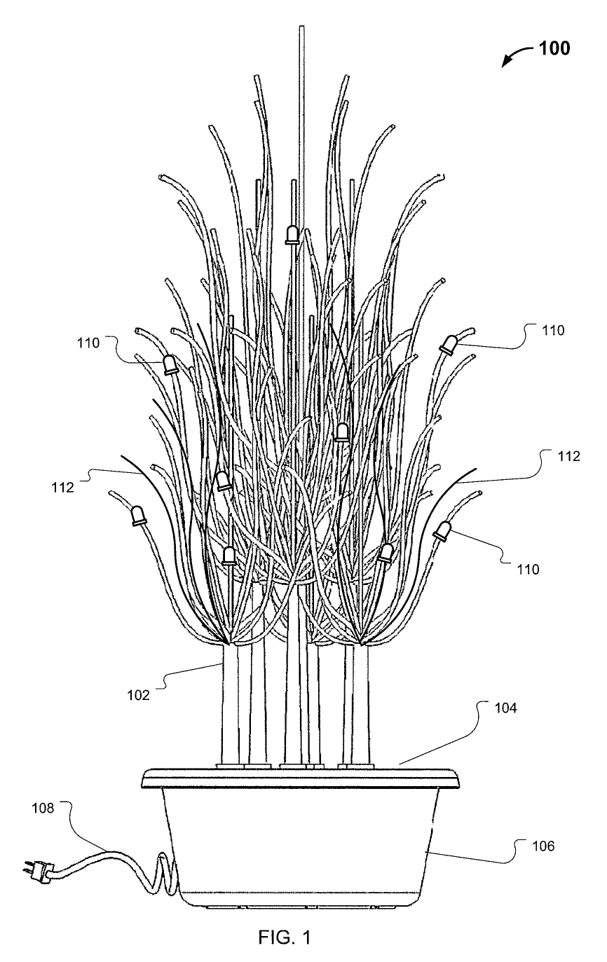

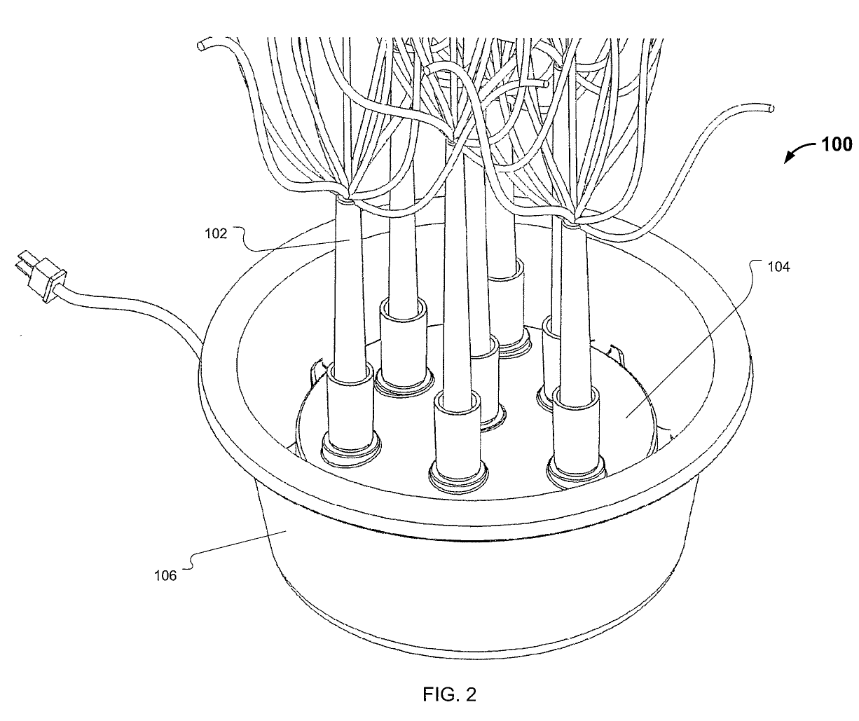

FIG. 1 shows an example of an artificial plant display 100. The artificial plant display 100 contains a plurality of individual plant sprays 102, a base unit 104 (not shown), an ornamental housing 106, and a power cord 108 extending from the base unit 104 through the ornamental housing 106. The individual plant sprays 102 are designed to resemble plant life, such as a potted plant, a flower arrangement, a bush, or a tree. For example, in an embodiment in which the artificial plant display 100 resembles a potted plant, the individual plant sprays 102 can contain structures resembling stems, branches, leaves, and flowers.

In the example depicted, the plant sprays 102 also contain a plurality of light emitting diodes (LEDs) 110 and fiber optic strands 112 that light up when the artificial plant display 100 is connected to a source of power. The individual plant sprays 102 are readily removable from the base unit 104 and interchangeable with other similar plant sprays. The plant sprays 102 are designed to be interchangeable so that the artificial plant display 100 can be customized to coincide with the season, a holiday, a sporting event, or the personal preferences of the user. For example, plant sprays resembling a poinsettia plant can be used around the Christmas holiday; an Irish themed display containing four leaf clovers can be used around Saint Patrick's day; or a display containing colored LED's that match the colors of a sports team can be used during a sporting event.

In the example depicted, the ornamental housing 106 is designed to resemble a pot that would house an ordinary potted plant. In alternate embodiments, the ornamental housing 106 can resemble a pile of rocks that match landscaping rocks, or the top of the ornamental housing 106 can be designed to resemble grass so that the ornamental housing 106 can be buried in a lawn with the top of the ornamental housing 106 lying flush with the lawn.

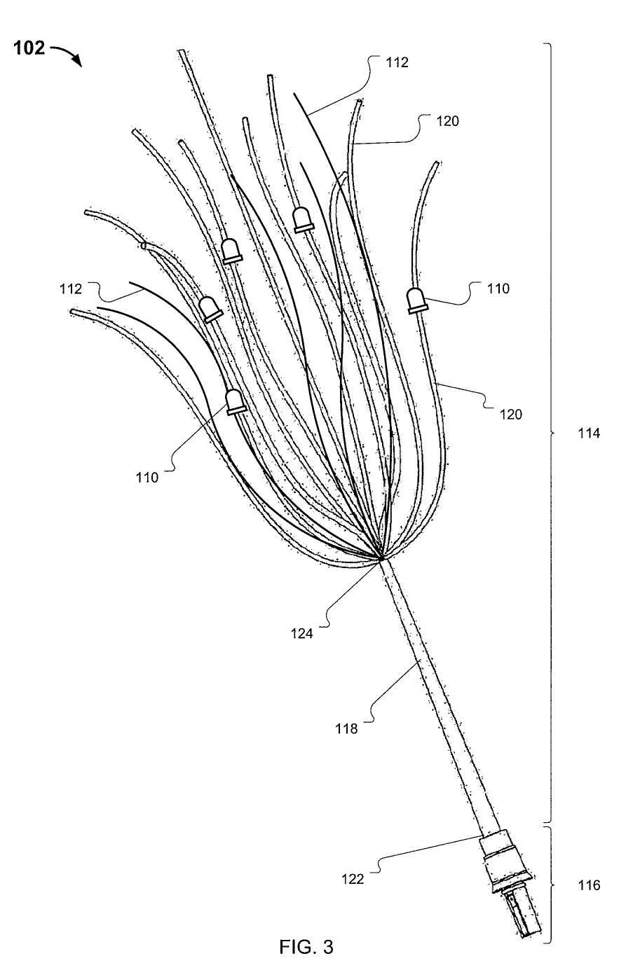

FIG. 2 shows a close up of the artificial plant display 100 from FIG. 1. Each individual plant spray 102 is mounted in a receptacle within the base unit 104. Each plant spray 102 forms a water resistant seal with the base unit 104 or includes a flashing or flange to prevent water from entering the receptacles in the base unit 104. Moreover, the base unit 104 is also substantially water resistant in ordinary outdoor environmental conditions. This makes the artificial plant display 100 suitable for both indoor and outdoor use.

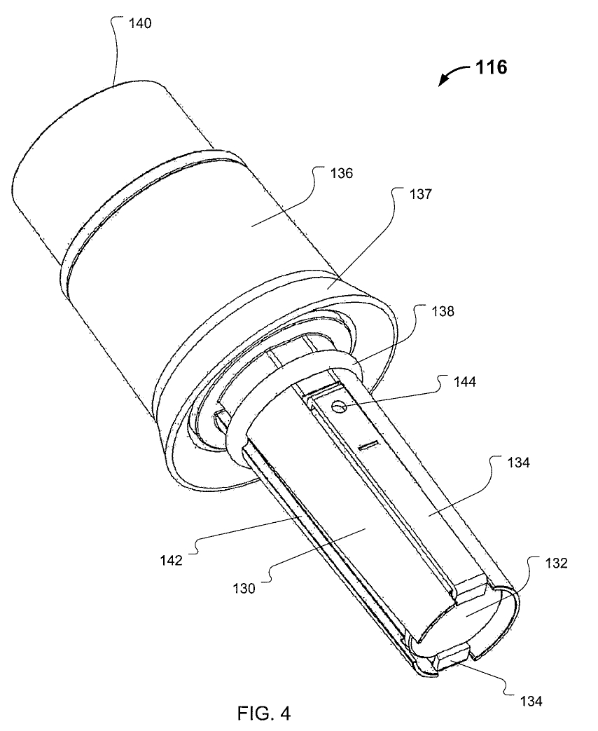

FIG. 3 shows a close up of a single individual plant spray 102 from FIG. 1. The individual plant spray 102 includes a display end 104 and a plug end 116. The display end 114 contains the plurality of LEDs 110 and fiber optic strands 112 as well as a support structure 118 designed to resemble a plant stem, and a plurality of plant structures 120 designed to resemble stems and leaves. In this example, the LEDs 110 are mounted to the plant structures 120. The LEDs 110 are connected to a source of electricity through a plurality of electrical wires. The wires that supply electricity to the LEDs 110 can be contained within the plant structures 120, or designed to resemble plant structures. This way, there are substantially no visible electrical wires in the individual plant spray 102. The wires enter the support structure 118 through a top end 124 and extend through the support structure 118, through a bottom end 122 of the support structure 118 and into the plug end 116.

The plurality of fiber optic strands 112 are bundled together within the support structure 118 and extend through the support structure 118 through the bottom end 122 and into the plug end 116. The fiber optic strands 112 extend through the top end 124 of the support structure 118. The tops of the fiber optic strands 112 are interspersed among the plant structures 120. When the plant spray 102 is coupled with the base unit 104, the bottom end of the bundle of fiber optic strands 112 is optically coupled to a light source, so that the fiber optic strands 112 light up when the light source is turned on.

The plug end 116 is inserted into a receptacle in the base unit 104 and contains means for optically and electrically coupling with the base unit 104. The plug end 104 also contains means for forming a water resistant seal with the base unit 104, and an alignment means for positioning the plant spray 102 in one or more predetermined orientations relative to the base unit 104.

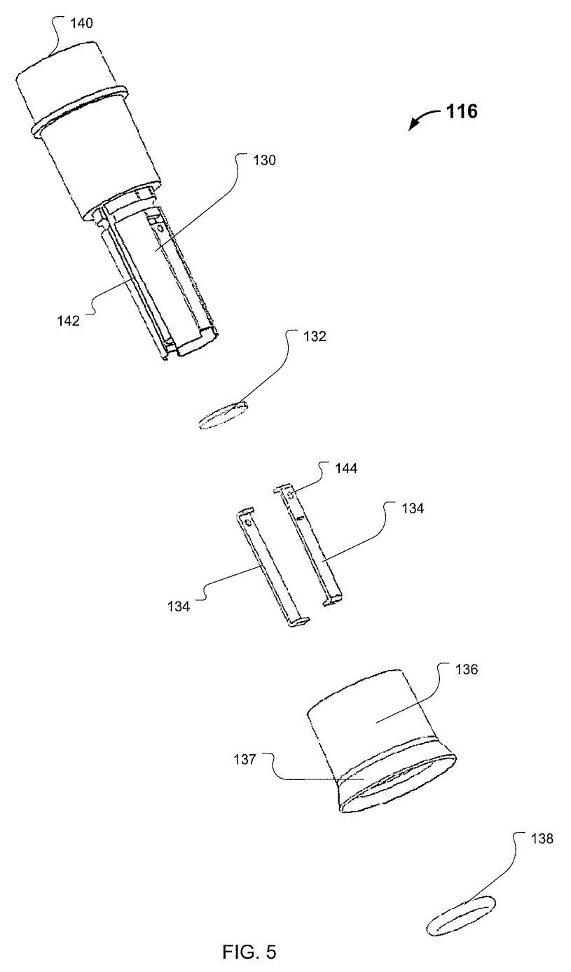

FIGS. 4 & 5 show a close up view of the plug end 116 from FIG. 3. FIG. 4 shows the plug end 116 in an assembled state while FIG. 5 shows the individual components of the plug end 116. The plug end 116 includes a plug 130, a lens 132, electrical contacts 134, a seal 136 and an o-ring 138. The plug 130 includes a top end 140 that connects to the bottom end 122 of the support structure 118 from FIG. 3. The bundle of fiber optic strands 112 extends through an opening in the top end 140. The plug 130 also includes an alignment notch 142 for positioning the plant spray 102 in one or more predetermined orientations relative to the base unit 104 to ensure that the electrical contacts 134 are properly aligned with corresponding electrical contacts in the base unit 104.

The electrical contacts 134 are mounted on the plug 130 so that they can contact corresponding electrical contacts in a receptacle in the base unit 104 when the individual plant spray 102 is inserted into a receptacle. The electrical contacts 134 are electrically connected to the LEDs 110 by a plurality of electrical wires. Each electrical contact 134 contains a hole 144 for electrically connecting with an end of one or more electrical wires that provide electricity to the LEDs 110. The electrical wires are contained within the plug 130 and extend up through the top end 140 and into the support structure 118. The electrical contacts 134 can be spring mounted to the plug 130 to ensure even contact with the corresponding electrical contacts in the base unit 104.

The lens 132 can be composed of a clear or translucent material and can be clear or colored. The lens 132 is optically coupled to the plurality of fiber optic strands 112. When the plant spray 102 is coupled to the base unit 104, light from a light source in the base unit 104 passes through the lens 132 and into the fiber optic strands 112. If the lens 132 is colored, the light will be filtered as it passes through the lens 132 so that the fiber optic strands 112 will take on the color of the lens 132. The lens 132 is readily removable from the plug 130 and is interchangeable with other similar lenses. Lenses of different colors can be exchanged to change the color of the fiber optic strands 112. The lens 132 can be a polycarbonate lens or can be composed of glass, or a plastic such as CR-39.

The seal 136 fits around the plug 130 and is designed to form a water resistant seal with the base unit 104 when the plant spray 102 is coupled to the base unit 104. The o-ring 138 fits around the plug 130 and is positioned below the seal 136. The o-ring 138 fits inside of a receptacle in the base unit 104 and holds the plant spray 102 in place when the plant spray 102 is coupled to the base unit 104. The o-ring 138 holds the plant spray 102 in place while allowing the plant spray 102 to be readily removable from the base unit 104. The seal 136 and the o-ring 138 can composed of rubber or some other suitable material.

In some embodiments, the plug end 136 does not require an o-ring 138 in order to form a substantially water resistant seal with the base unit 104. The seal 136 can include a flange 137 that extends out beyond the circumference of a receiving receptacle in the base unit 104 when the plant spray is coupled to the base unit 104. Water from rain or other conditions can flow down the plant spray 102, over the plug 136 and over the flange 137. The flange 137 will ensure that the water flows beyond the circumference of the receiving receptacle and onto an outer top surface of the base unit 104. The base unit 104 can be designed with a sloping outer top surface so that water will run off of the base unit 104. Further more, the base unit 104 can be designed with raised ridges around each of the receiving receptacles so that run off water from one plant spray 102 does not flow into the respective receiving receptacle of a another plant spray 102.

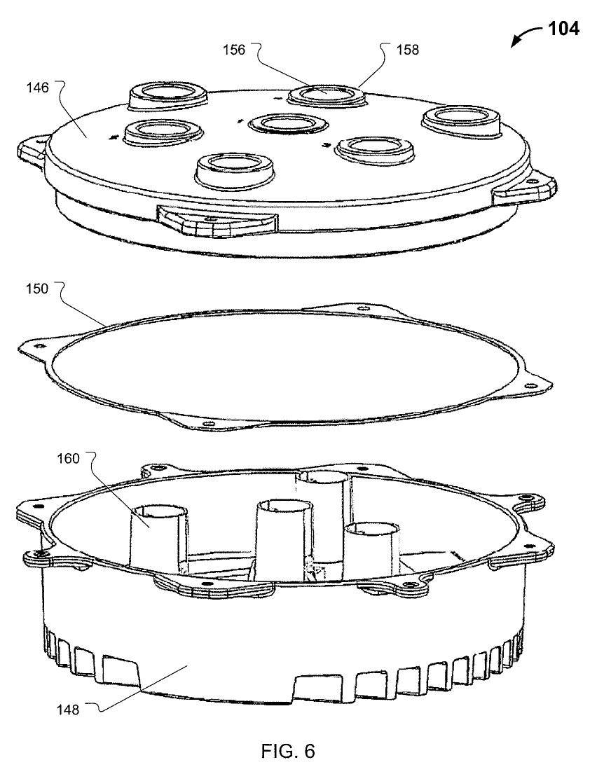

FIG. 6 shows a close up view of the components that make up the base unit 104 from FIG. 2. The base unit includes a top portion 146, a bottom portion 148, and a ring 150. The ring 150 forms a water resistant seal between the top portion 146 and the bottom portion 148. The ring 150 can be composed of rubber, carbon graphite, tungsten carbide, silicon carbide, plastic, or a ceramic material. The water resistant seal allows the base unit 104 to substantially inhibit water intrusion during normal exposure to outdoor weather conditions. The top portion 146, bottom portion 148, and ring 150 can be mounted together with a plurality of screws and washers.

The top portion 146 includes a number of openings 156, each opening 156 configured to receive the plug end 116 of one of the plant sprays 102. Each opening 156 is surrounded by a ridge 158 that forms part of the water resistant seal with the seal 136 from FIG. 4. The seal formed between the seal 136 and the ridge 158 substantially inhibits water intrusion during normal exposure to outdoor weather conditions. By protruding above the top outer surface of the top portion 146, the ridges 158 help to ensure that run off water from exposure to normal weather conditions, such as rain, does not enter the openings 156. The ridges 158 also help to ensure that the plant sprays 102 are aligned at the same height when coupled with the base unit 104. The top portion 146 can be designed so that the top outer surface is slopped. In this way, water, such as rain water, will run off of the base unit and is less likely to enter the openings 156.

The bottom portion 148 of the base unit 104 includes a number of receptacles 160 aligned beneath the openings 156. In the example depicted, only some of the openings 156 are aligned with receptacles 160. The other openings 156 are designed to receive plant sprays that contain no LEDs or fiber optic strands, and therefore have no need for an electrical or optical coupling. Each receptacle 160 is configured to receive the plug end 116 of one of the plant sprays 102.

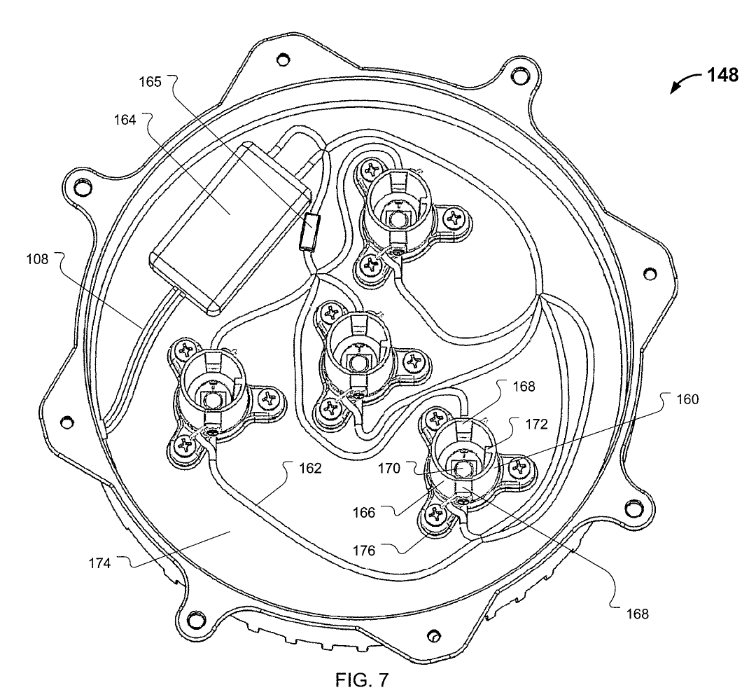

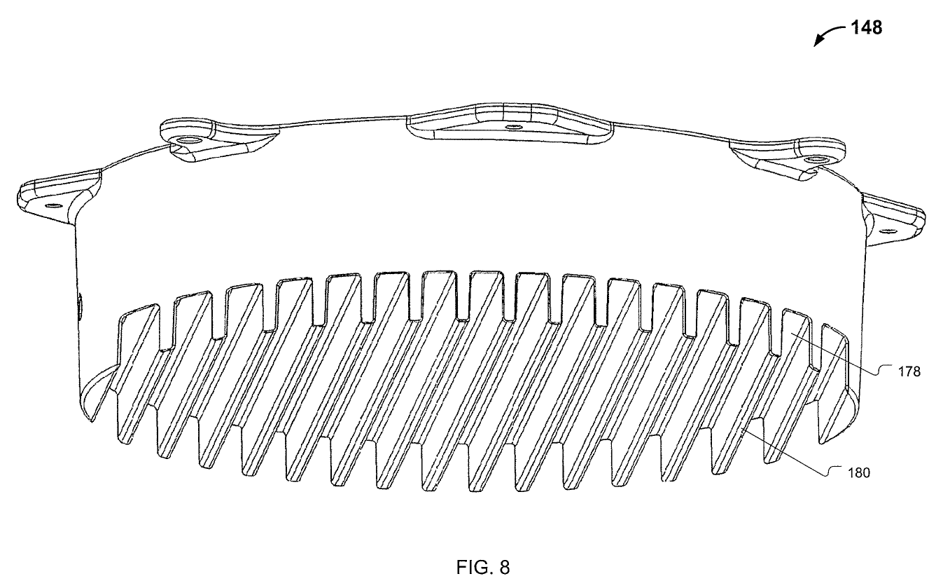

FIG. 7 shows a close up view of the bottom portion 148 of the base unit 104 from FIG. 6. The bottom portion 148 includes a surface 174 on which a number of the receptacles 160 are arranged. The surface 174 comprises a substantially planar surface. In addition, the bottom portion 148 includes a plurality of electrical wires 162 for supplying electricity to the receptacles 160 and a power source 164 that is electrically coupled to the electrical wires 162. In this example, the power source 164 is connected to the power cable 108 from FIG. 1. The power source 164 can be a AC to DC adapter. The power cable can be plugged into a 110 VAC wall outlet to provide electricity to the artificial plant display 100. In another embodiment, the power source 164 can be a battery mount for receiving conventional batteries, for example, AA batteries. In yet another embodiment, the power source 164 can include a rechargeable battery that is connected to a solar panel located outside of the base unit 104. When exposed to sunlight, or another source of light, the solar panel can recharge the power source 164.

Each receptacle 160 includes a wall 166; a number of electrical contacts 168 mounted to the wall 166; and an LED 170 positioned at the bottom of the receptacle 160. The wall 166 can be composed of an insulating material such as PVC pipe or a high temperature plastic. In some embodiments, the wall 166 preferably have a heat transfer coefficient below 1 W/(m·K) and even more preferably below 0.2 W/(m·K). The wall 166 includes one or more alignment ridges 172 for aligning with the alignment notch 142 of the plant spray 102 to ensure that the plant spray 102 is positioned in one or more predetermined orientations relative to the base unit 104 when the plant spray 102 is coupled to the base unit 104. In alternate embodiments, the wall 166 can have a non-circular shape, such as an octagon, rectangle, or irregular polygon, to ensure proper alignment of the play spray 102 with the receptacle 160.

The electrical contacts 168 are mounted to the wall 166 and electrically coupled to one or more of the wires 162. The electrical contacts 168 are positioned to electrically couple with the contacts 134 on the plant spray 102 when the plant spray 102 is coupled to the base unit 104. The electrical contacts 138 allow electricity to flow from the power source 164 to the LEDs 110.

The LED 170 positioned at the bottom of the receptacle services as a light source for plurality the fiber optic strands 112 from FIG. 1. The LED 170 is electrically coupled to one or more of the wires 162 in order to receive electricity from the power source 164. When the plant spray 102 is coupled to the receptacle 160, the LED 170 is optically coupled to both the lens 132 and the fiber optic strands 112 in the plant spray 102. In the example depicted, the LEDs 170 emit white light and the color displayed by the fiber optic strands 112 is changed by exchanging various colored lenses 132 into the plug end 116 of the plant spray 102. In alternate embodiments, the LEDs 170 can be readily removable and interchangeable with other colored LEDs, so that the color of the LED 170 determines the color displayed by the fiber optic strands 112.

The power source 164 can supply low voltage DC power for powering the LEDs 170 and the LEDs 110. A current limiting resistor 165 can be used to supply a correct current to the LEDs 170 and 110. Typical LED currents range from 2 mA to 20 mA.

In the example depicted, the receptacle 160 is mounted to the surface 174 by a mounting bracket 176. The mounting bracket 176 is made of a thermally conductive material such as copper or aluminum. In some embodiments, the mounting bracket 176 will ideally have a thermal conductivity greater than 200 W/(m·K). The mounting bracket 176 is thermally connected to both the LED 170 and the surface 174 to transfer heat away from the LED 170. The surface 174 is also made of a thermally conductive material, such as aluminum, and acts as a heat sink to draw heat away from the receptacle 160 and the LED 170. The surface 174 can also act as a heat sink to draw heat away from other electrical components of the base unit 104 such as the power supply 164, the electrical wires 162, and the resistor 165. In alternate embodiments, the surface 174 can be a thermally insulative material and a metal trace can be connected to the LED 170 and run through the surface 174 to a bottom side of the bottom portion 148. This thermally connects the LED 170 to the bottom side of the bottom portion 148 and promotes heat dissipation away from the LED 170. In another alternate embodiment, the LED 170 can be mounted directly onto the surface 174. This way the LED would be directly thermally connected to the surface 174, leading to an increase in heat dissipation away from the LED 170.

In some embodiments, the base unit 104 can include a thermally insulative seal between the bottom portion 148 and the top portion 146. The base unit 104 can additionally include polymeric fasteners, or otherwise thermally insulative fasteners such that the bottom portion 148 is substantially thermally insulated from the top portion 146. This can protect the plant sprays 102 and users from heat generated by the LEDs 170 and dissipated by the bottom portion 148.

In yet another alternate embodiment, heat dissipation can be achieved by installing one or more cooling fans into the base unit 104. The base unit 104 can include several ventilation holes. The ventilation holes can be placed in the bottom of the base unit 104 so as not to permit rainwater to enter the base unit 104. The cooling fans can draw in cooler air from outside of the base unit 104 and blow hot air out of the base unit 104 through the ventilation holes and away from the LEDs 170 and other electrical components. Furthermore, the walls 166 of the receptacles 160 can contain ventilation holes to allow the cooling fans to circulate cool air around the LEDs 170 and draw hot air away from the LEDs 170. In other embodiments, two or more of the above described methods for heat dissipation can be combined.

FIG. 8 shows a bottom view of the bottom portion 148 from FIG. 6. In addition to the features described above, the bottom portion 148 includes a bottom surface 178 which includes a plurality of fins 180. The bottom surface 178 and fins 180 are made of a thermally conductive material, such as aluminum or copper, and are thermally connected to the surface 174 from FIG. 7. In some embodiments, the bottom surface 178 and fins 180 will ideally have a thermal conductivity greater than 200 W/(m·K). In this example, the surface 174, the bottom surface 178, the fins 180 and the rest of the outside part of the bottom portion 148 are integrally constructed. In other embodiments, these components can be constructed from separate pieces. The bottom surface 178 acts as a heat sink and draws heat away from the surface 174 and the electrical components of the bottom portion 148. The fins 180 increase the total surface area of the bottom surface 178 increasing the amount of air exposed to the bottom surface. This promotes increased heat transfer away from the base unit 104.

In an alternate embodiment, the bottom portion 148 can be designed so that a gap exists between the main portion of the bottom portion 148 and the bottom surface 178 and fins 180. This can allow for convective heat transfer between the bottom portion 148 and the bottom surface 178 and fins 180.

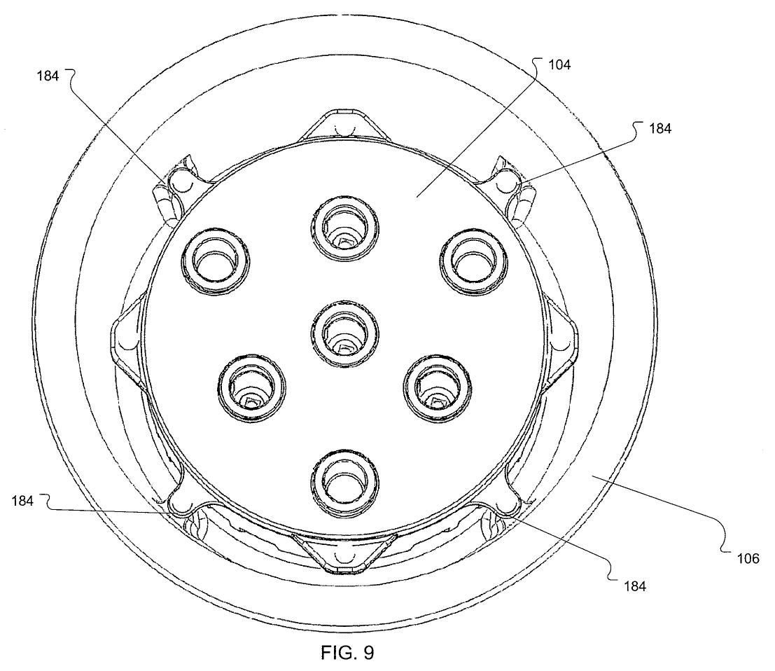

FIG. 9 shows the base unit 104 mounted to the ornamental housing 106. The base unit 104 is attached to the ornamental housing 106 at a limited number of contact points 184 so that the base unit 104 is substantially spaced apart from the housing. The base unit 104 is further positioned so that it is suspended above the bottom of the ornamental housing 106. This allows air to circulate around the sides of the base unit 104, the bottom surface 178, and the fins 180. This air circulation draws heat away from the base unit 104.

In some embodiments, the base unit 104 is suspended high enough above the bottom of the ornamental housing 106 so that water that collects in the ornamental housing 106 does not inhibit the flow of air over the bottom surface 178. In some embodiments, the ornamental housing 106 can contain a number of ventilation holes to further promote air circulation around the base unit 104.

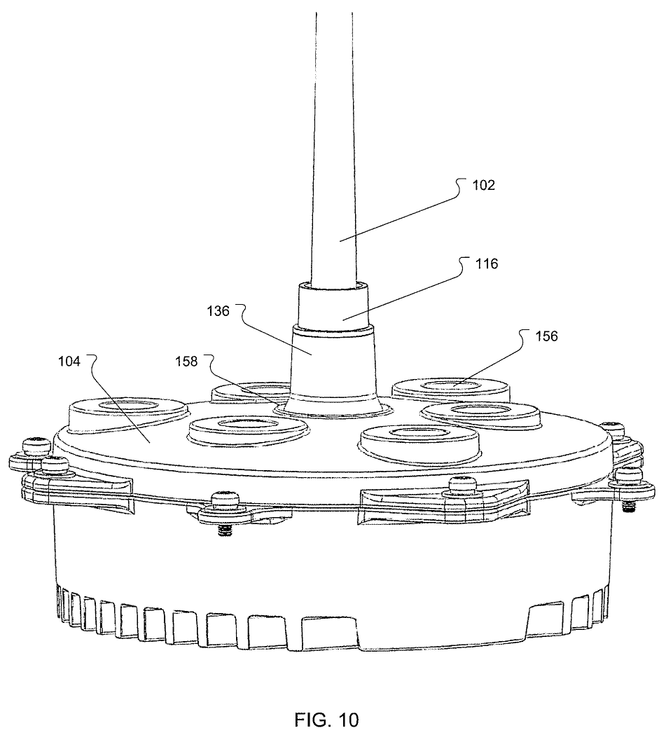

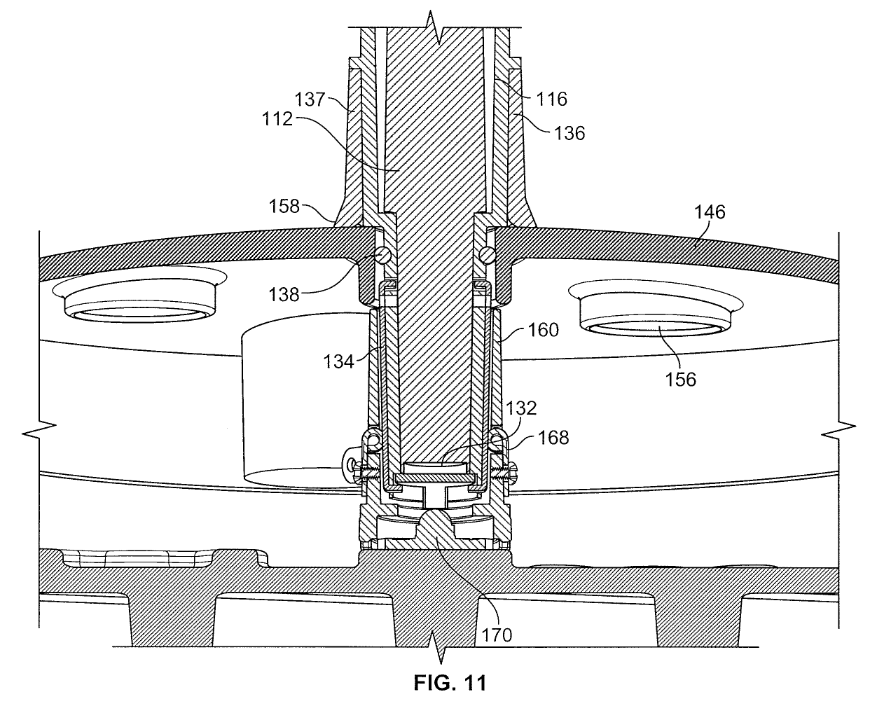

FIG. 10 shows one of the plant sprays 102 coupled to the base unit 104. The plug end 116 (not shown) of the plant spray 102 is inserted into one of the openings 156. When the plug end 116 is fully inserted into the base unit 104, the seal 136 forms a substantially water resistant seal with the ridge 158 that surrounds the opening 156.

FIG. 11 shows a cross section of the coupling of the plant spray 102 and the base unit 104 depicted in FIG. 10. The plug end 116 of the plant spray 102 is releasably coupled to the receptacle 160. The alignment notch 142 (not shown) from FIG. 4 and the alignment ridge (not shown) from FIG. 7 are aligned so that the plant spray 102 is positioned in the correct predetermined orientation. The plant spray 102 is positioned so that the electrical contacts 134 and the electrical contacts 168 are aligned and electrically coupled. This completes an electrical circuit that extends from the power chord 108 (not shown) to the LEDs 110 (not shown).

The plant spray 102 is also positioned so that the LED 170 is aligned with and optically coupled to the lens 132 and the plurality of fiber optic strands 112. When electricity is supplied to the LED 170, the LED 170 lights up and light is transferred through the lens 132 and the fiber optic strands 112. The seal 136 forms a substantially water resistant seal with the ridge 158 that surrounds the opening 156. The o-ring 138 holds the plug end 116 in place within the receptacle 160. The flange 137 extends beyond the circumference of the opening 156. This way, when the artificial plant display 100 is exposed to water during normal weather conditions, such as rain, the water will run down the plant spray 102, over the flange 137 and beyond the edge of the opening 136. The raised ridge 158 surrounding each opening 156 ensures that run off water from one plant spray 102 does not flow into the respective opening 156 of a different plant spray 102.

In an alternate embodiment to the coupling in the example depicted, the lens 132 can be located further up in the plug end 116 so that it is located near the top of the plug end 116 in the portion of the plug end 116 that is above the top portion 146 of the base unit 104. The portion of the plug end 116 that is inserted into the receptacle 160 can then be decreased in diameter and the receptacle 160 can be decreased in diameter. The light from the LED 170 would be transmitted by the lens 132 into the plurality of fiber optic strands 112. This alternate embodiment can allow for the plant sprays 102 to be positioned more closely together, and further inhibit water from entering the base unit 104 through the openings 156.

In another alternate embodiment the lens 132 can include two or more colors, so that one half (or another fraction) of the lens 132 would be one color and the other half (or other fraction) of the lens 132 would be a second color. The plug end 116 of the plant spray 102 can include two or more alignment notches 142 so that the plant spray 102 can be positioned in more than one orientation relative to the base 104. The LED 170 can be positioned so that it only illuminates half (or another fraction) of the lens. Therefore the light passing through the lens 132 would take on the first color when the plant spray 102 is positioned in a first orientation, and the lens 132 would take on the second color when the plant spray 102 is positioned in a second orientation. The plant spray 102 can also be positioned in a third orientation in which light passes through portions of both halves of the lens so that different fiber optic strands 112 would take on different colors.

In a similar embodiment to the above mentioned embodiment, the receptacle 160 can include multiple LEDs of different colors. The plant spray 102 can include a means for only allowing light from one of the LEDs to enter the plug end 116 and transmit through the fiber optic strands 112. In this way, the color of the light transmitted through the fiber optic strands 112 can be changed depending on the orientation of the plant spray 102.

In addition, the plug end 116 can include multiple pairs of electrical contacts 134 with each set of electrical contacts 134 electrically coupled to a different set of LEDs 110. When the plant spray 102 is positioned in different orientations, only the pair of electrical contacts 134 that correspond to a particular orientation will contact the electrical contacts 168 in the base unit. This will cause only the LEDs 110 that are electrically coupled to that pair of electrical contacts 134 to light up. Each different set of LEDs 110 can have a color scheme that complements the color of the light that is passing through the lens in that particular orientation.

For example there can be a yellow orientation, a blue orientation, and a green orientation all on the same plant spray 102. For each orientation, the lens 132 is positioned so that only the portion of the lens that corresponds to the color of that orientation is exposed to the light emitted by the LED 170. Therefore, the fiber optic strands 112 will be illuminated with that color. Furthermore, only the LEDs 110 that correspond to the color of that orientation will light up.

In another alternate embodiment, rather than (or in addition to) extending into the base unit 104, the plug end 116 can be designed with a flat surface that magnetically couples with a corresponding flat surface on the base unit 104. In this embodiment, the bottom of the plug end 116 can be a flat surface with a magnetic ring disposed about the outer edge. The middle of the flat surface can contain a lens and one or more electrical contacts can be placed on the flat surface between the lens and the outer magnetic edge. The corresponding opening on the base unit 104 can be covered with a clear lens to allow light to transfer from the LED 170 in the base unit to the plant spray 102. The opening can be encircled by a magnet with an opposite magnetic polarity than the magnet encircling the flat surface of the plug end 116. One or more electrical contacts can be placed near the opening between the clear lens and the circular magnet to electrically couple with the corresponding contacts on the plug end 116. In order to ensure proper alignment of the plant spray 102 with the base unit 104, the outer edge of the plug end can include a magnet of a north polarity on one side and a magnet of a south polarity on the other. The magnets on the base unit 104 can have corresponding polarities to ensure that the plant spray 102 is positioned in the correct orientation.

Another alternate embodiment of the artificial plant display 100 includes using an alternative light source instead of the LEDs 170 at the base of each receptacle 160. In the alternative embodiment, a single light source can be placed within the base unit 104 so that the light emitted by the light source would shine in a direction substantially perpendicular to the plant sprays 102. Each receptacle 160 can include an opening in the wall 166 allowing light from the light source to shine into the receptacle. A mirror can be positioned at the bottom of each receptacle 160 instead of an LED. The mirror would reflect the light from the light source up through the lens 132 and the fiber optic strands 112 in the plant spray 102. Since there is only one light source in this embodiment, only one light source would need to be replaced when it burns out. Furthermore, having only one light source means that there is only one significant source of heat, instead of multiple heat sources. This can allow for easier removal of heat away from the base unit 104.

In an alternative embodiment to the above mentioned embodiment, two light sources can be used, with the light sources positioned at opposite ends of the base unit 104 with each light source shining in the direction of the center of the base unit 104. Each light source can have a different color. Each receptacle 160 can include two mirrors at the base, each mirror being positioned to reflect light from one of the light sources up through the lens 132 and the fiber optic strands 112 of the plant spray 102. Each plant spray 102 can further include a means for only transmitting the light from one of the two mirrors through the lens 132 and the fiber optic strands 112. This way, the color of the light being transmitted by the fiber optic strands 112 can be changed by changing the orientation of the plant spray 102 within the receptacle 160

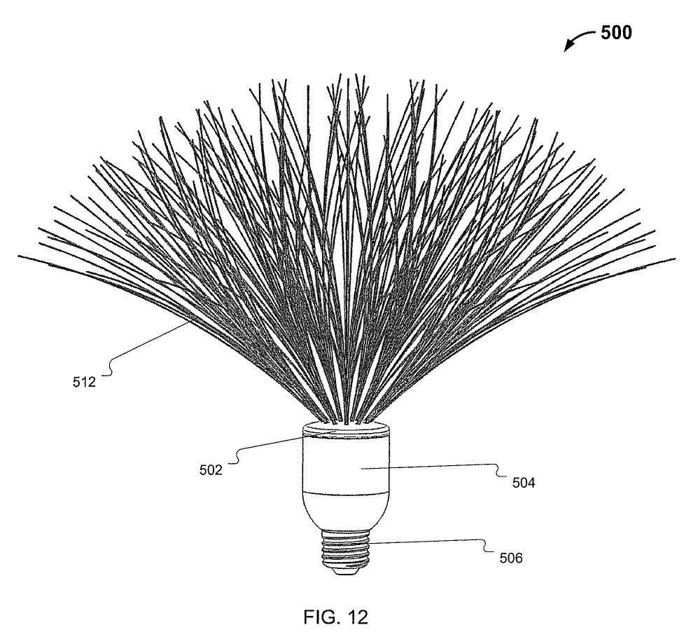

FIG. 12 shows an example of an alternate embodiment of an artificial plant display 500. The artificial plant display 500 includes an individual plant spray 502, and a bulb unit 504. The individual plant spray 502 is designed to resemble plant life, such as a flower arrangement, a potted plant, a bush, or a tree. For example, in an embodiment in which the artificial plant display 500 resembles a potted plant, the individual plant spray 502 can contain structures resembling stems, branches, leaves, and flowers.

In the example depicted, the plant spray 502 also contains a plurality of fiber optic strands 512 that light up when the artificial plant display 500 is connected to a source of power. The individual plant spray 502 is readily removable from the bulb unit 504 and interchangeable with other similar plant sprays. The plant spray 502 is designed to be interchangeable so that the artificial plant display 500 can be customized to coincide with the season, a holiday, a sporting event, or the personal preferences of the user. For example, a plant spray resembling a poinsettia plant can be used around the Christmas holiday. In some embodiments, the plant spray 502 can also include a plurality of LEDs that light up when the artificial plant display 500 is connected to a source of power.

The bulb unit 504 includes a threaded coupling 506 for coupling with a light fixture such as a standard North American E26 light fixture. For example, the threaded coupling 506 can be coupled to a 120 volt light fixture. The threaded coupling 506 can electrically couple with a light fixture to supply power to the artificial plant display 500. The threads of the threaded coupling 506 help to secure the bulb unit 504 in place when it is coupled to a light fixture.

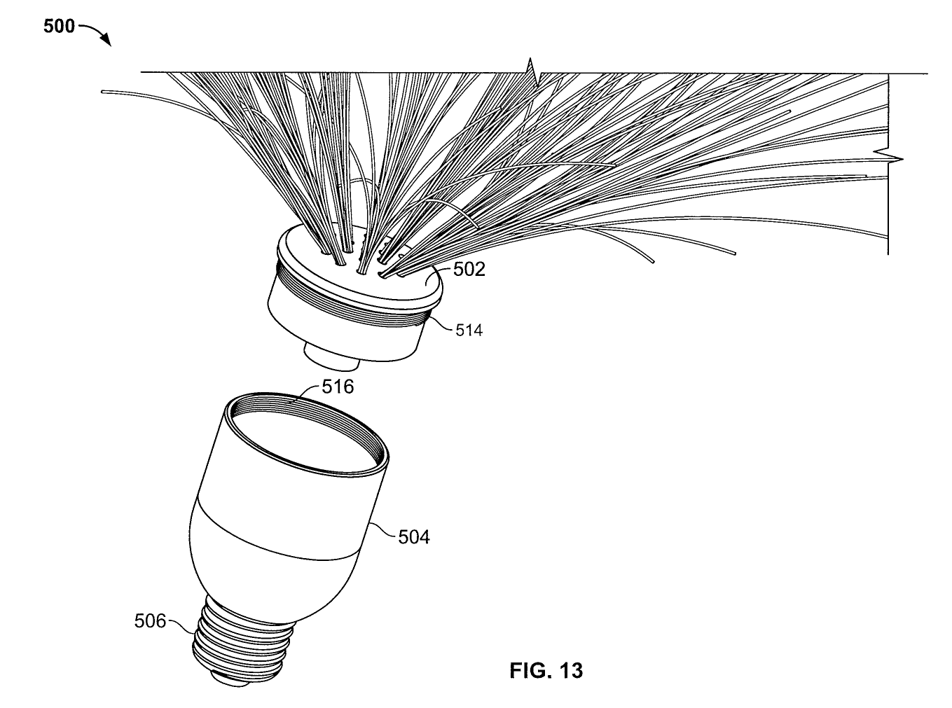

FIG. 13 shows a close up view of the artificial plant display 500 in which the plant spray 502 has been separated from the bulb unit 504. The plant spray 502 includes a threaded portion 514 and the bulb unit 504 includes a threaded portion 516. The threaded portion 514 of the plant spray 502 can screw into the threaded portion 516 of the bulb unit 504 to secure the plant spray 502 to the bulb unit 504.

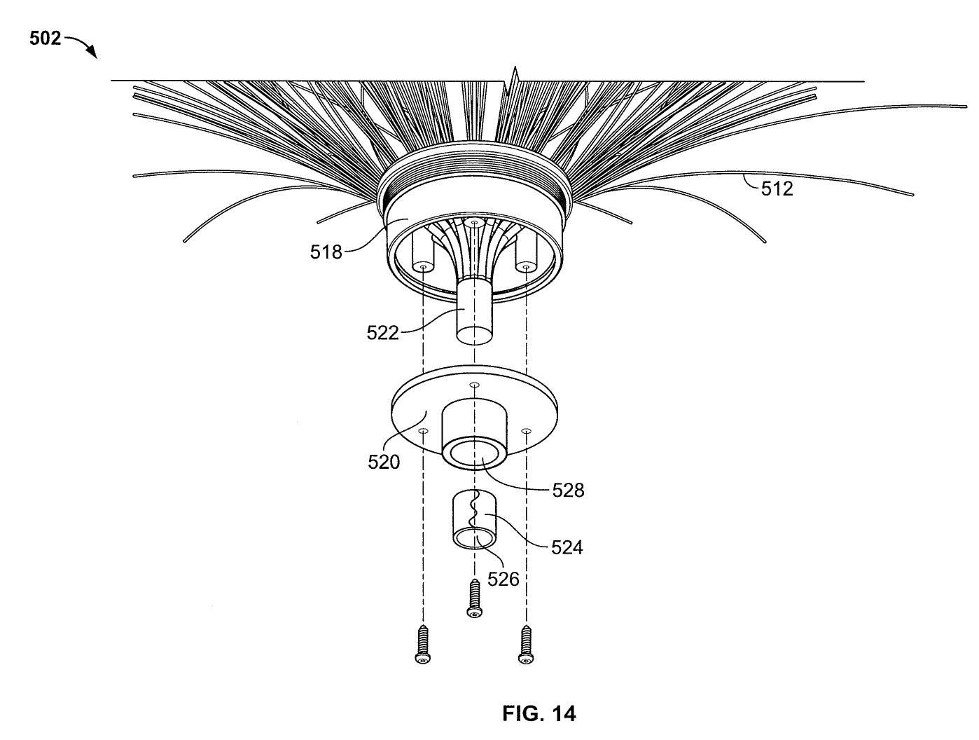

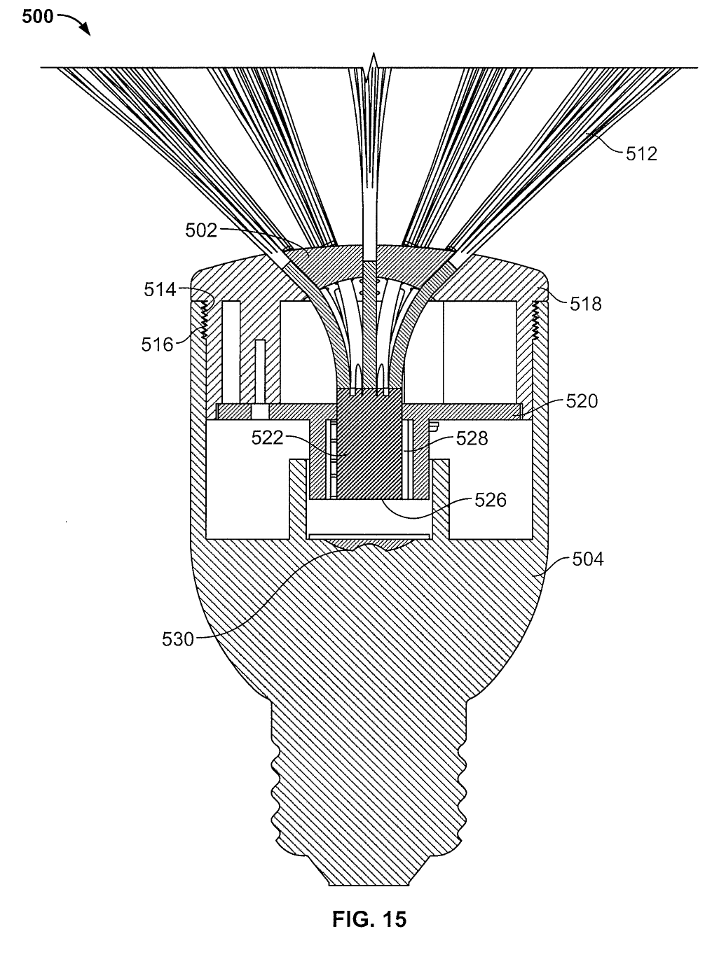

FIG. 14 shows a close up of the individual components of the plant spray 502. The plant spray 502 includes a top portion 518 and a bottom portion 520. The top portion 518 of the plant spray 502 holds the artificial plant structures and the plurality of fiber optic strands 512 in place. The plurality of fiber optic strands 512 pass through the top portion 518 and are gathered together in a fiber optic bundle 522 below the top portion 518.

The plant spray 502 further includes a lens mount 524 and a lens 526. The lens 526 fits inside of the lens mount 524. The lens mount fits around the fiber optic bundle 522 and inside of an opening 528 in the bottom portion 520. In this way, the fiber optic bundle 522 is optically coupled to the lens 526. The lens 526 can be composed of a clear or translucent material and can be clear or colored. When the plant spray 502 is coupled to the bulb unit 504, light from a light source in the bulb unit 504 passes through the lens 526 and into the fiber optic strands 512. If the lens 526 is colored, the light will be filtered as it passes through the lens 526 so that the fiber optic strands 512 will take on the color of the lens 526. The lens 526 is readily removable from the plant spray 502 and is interchangeable with other similar lenses. Lenses of different colors can be exchanged to change the color of the fiber optic strands 512. The lens 526 can be a polycarbonate lens or can be composed of glass, or a plastic such as CR-39.

FIG. 15 shows a cross section of the artificial plant display 500 when the plant spray 502 is coupled to the bulb unit 504. The example shows the plurality of fiber optic strands 512 passing through the top portion 518 of the plant spray 502 and gathering into the fiber optic bundle 522. The fiber optic bundle is located within the opening 528 of the bottom portion 520 of the plant spray 502. The threaded portion 514 of the plant spray 502 is screwed into the threaded portion 516 of the bulb unit 504 so that the plant spray 502 is releasably coupled to the bulb unit 504.

The bulb unit 504 includes a light source 530 such as an LED. The plant spray 502 is positioned so that the light source 530 is aligned with and optically coupled to the lens 526 and the plurality of fiber optic strands 512. When electricity is supplied to the light source 530, the light source 530 lights up and light is transferred through the lens 526 and the fiber optic strands 512. In some embodiments, the light source 530 can be readily removable so that light sources of varying colors can be swapped in and out to change the color of the artificial plant display 500. This can make the need for interchangeable colored lenses unnecessary.

In some embodiments the light source 530 can be thermally and physically connected to a mounting bracket which is connected to an inside surface of the bulb unit 504. The surface of the bulb unit 504 can be made of a thermally conductive material, such as aluminum, and act as a heat sink to draw heat away from the light source 530. The surface of the bulb unit 504 can also act as a heat sink to draw heat away from other electrical components of the bulb unit 504. In some embodiments, the surface of the bulb unit 504 can be made of a thermally insulative material and a metal trace can be connected to the light source 530 and run through the surface to an outside portion of the bulb unit 504. This thermally connects the light source 530 to the outside of the bulb unit 504 and promotes heat dissipation away from the light source 530.

In some embodiments, the bulb unit 504 can include one or more electrical contacts for electrically coupling with the plant spray 502. The plant spray 502 can also include one or more electrical contacts for contacting the electrical contacts in the bulb unit 504. The plant spray 502 can further include a plurality of electrical wires coupled to the electrical contacts in the plant spray 502 for transmitting electricity to LEDs or other light sources located in the plant structures of the plant spray 502.

In some embodiments, the top portion 518 of the plant spray 502 can include a flange that extends out beyond the circumference of the bulb unit 504 to make the artificial plant display substantially water resistant. The flange can ensure that water that collects on the plant spray 502 during normal exposure can flow beyond the outer circumference of the bulb unit 504 and away from the artificial plant display 500.

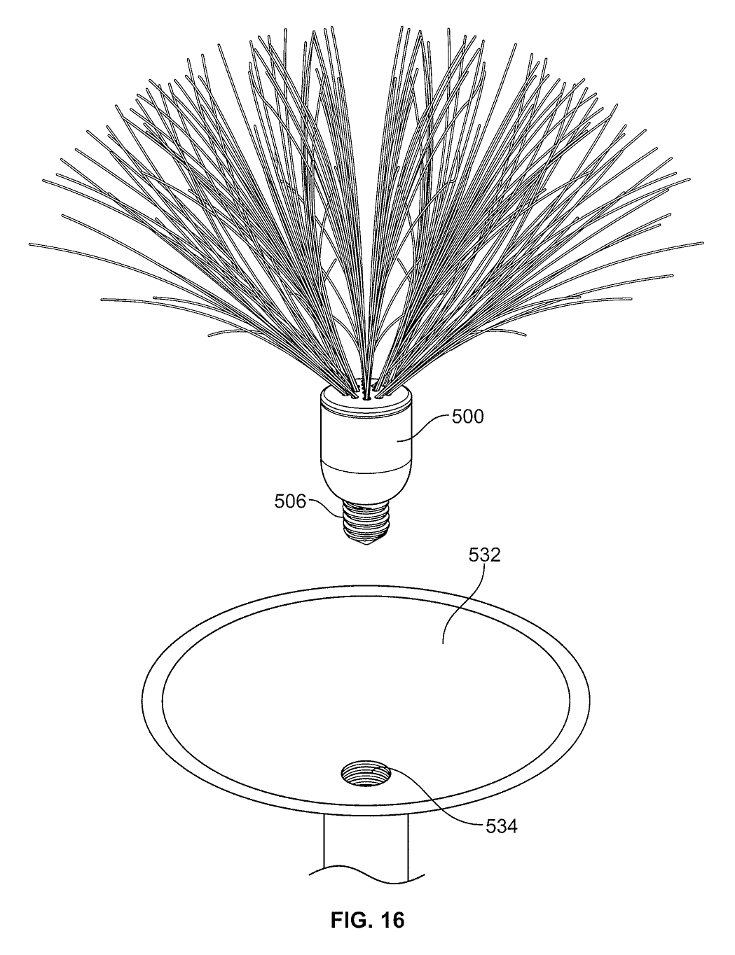

FIG. 16 shows the artificial plant display 500 in relation to a mounting structure 532. In the example depicted, the mounting structure 532 is a lamp. The mounting structure 532 includes a light fixture 534. The light fixture 534 includes threads so that the threaded coupling 506 can be screwed into the light fixture 534. When the artificial plant display 500 is screwed into the light fixture 534, the artificial plant display 500 is electrically coupled to the light fixture 534. This electric coupling provides electricity for lighting the artificial plant display 500.

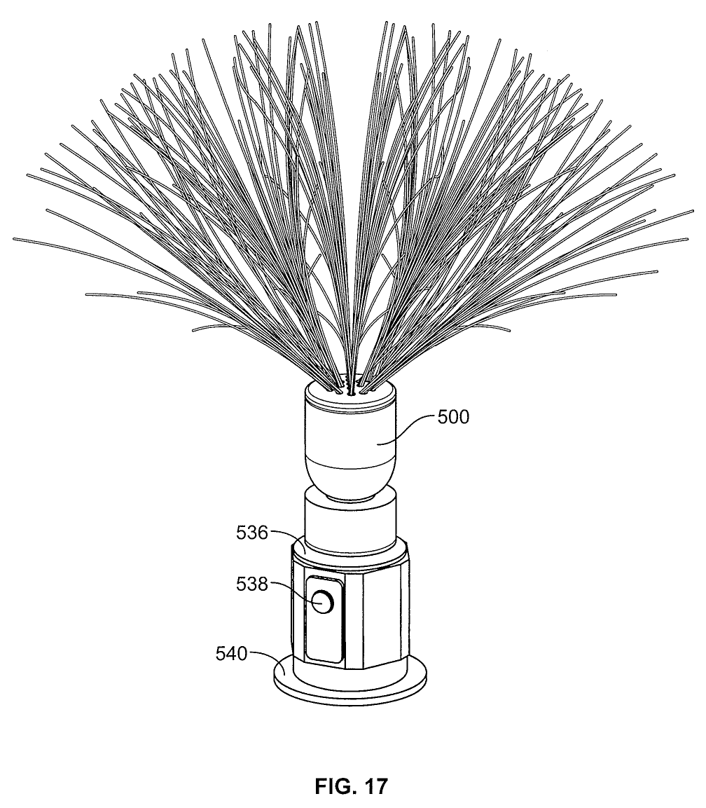

FIG. 17 shows the artificial plant display 500 coupled to a mounting unit 536. The mounting unit 536 is battery powered and provides electricity to the artificial plant display 500 so that the artificial plant display 500 can be easily moved and placed in locations that are not near a wall outlet or other source of electricity. The mounting unit 536 includes a threaded fixture for receiving the threaded coupling 506 of the artificial plant structure 500. The mounting unit 536 also includes a switch 538 for switching the flow of electricity to the artificial plant display 500 on and off.

In some embodiments, the mounting unit 536 can include a magnetic base 540. This way, the mounting unit 536 can be mounted to a structure or object that is made of a magnetic material such as iron, nickel, cobalt or steel. For example, the magnetic base 540 could be used to mount the mounting unit to the under side of a shelf made of iron, or to the side of a wall made of steel. In some embodiments, the magnetic base 540 can be used in conjunction with one or more metal adapter plates. A metal adapter plate can be a plate made of a magnetic metal such as iron, nickel, cobalt, or steel. One side of the metal adapter plate can be covered with an adhesive so that the metal adapter plate can be stuck to a non-magnetic surface. In this way, the magnetic base 540 can magnetically couple to the metal adapter plate so that the mounting unit 540 can be mounted to non-magnetic surfaces. For example, several metal adapter plates can be placed around a house, such as on the under side of kitchen cabinets or on the ceiling in different rooms. The mounting unit 536 can be moved from place to place and magnetically coupled to the different metal adapter units so that the artificial plant display 500 can be displayed in different locations at different times and easily moved from location to location.

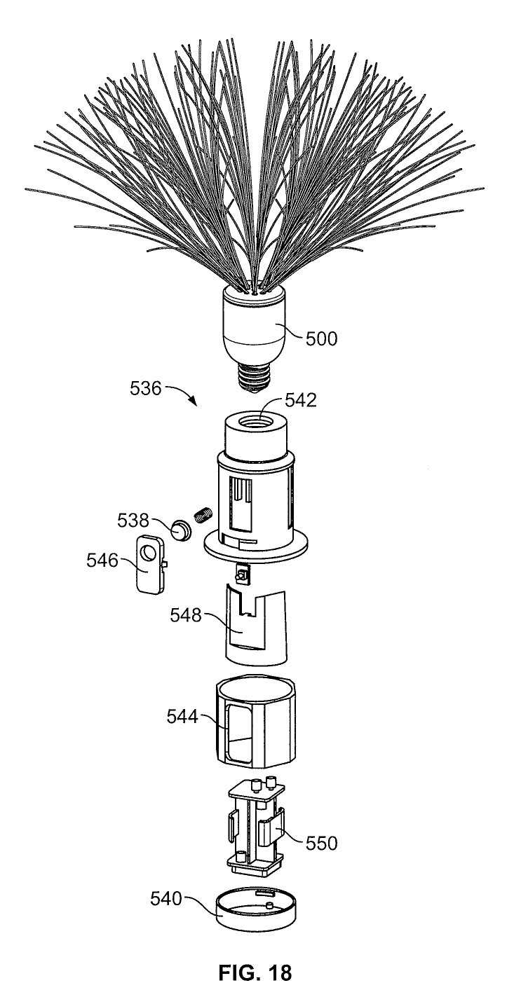

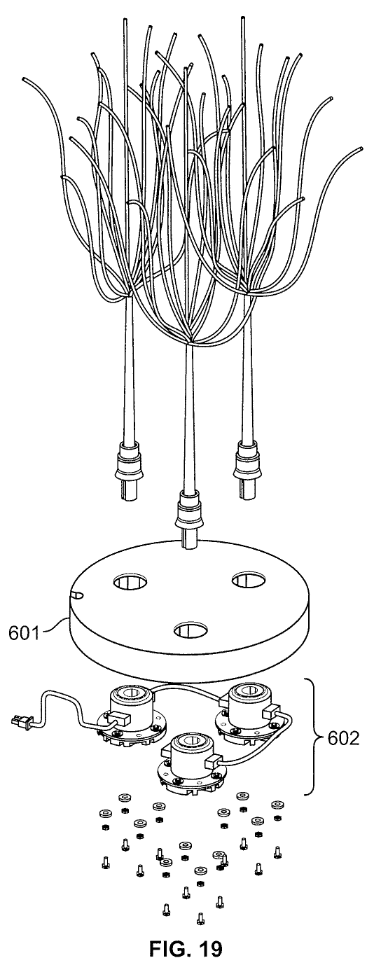

FIG. 18 shows the individual components of the mounting unit 536. In addition to the switch 538 and the magnetic base 540, the base unit includes a fixture 542 for receiving the artificial plant display 500. The fixture 542 includes threads so that the threaded coupling 506 can be screwed into the fixture 542. When the artificial plant display 500 is screwed into the fixture 542, the artificial plant display 500 is electrically coupled to the fixture 542. This electric coupling provides electricity for lighting the artificial plant display 500.

The mounting unit 536 further includes a housing 544, a switch cover 546, an inside cover 548, and a battery pack 550. The battery pack 550 can hold one or more batteries for supplying electricity to the artificial plant display 500. For example, the battery pack 550 can hold standard 1.5 volt AA batteries or D batteries, or rechargeable nickel-cadmium batteries. The battery pack 550 is electrically connected to the fixture 542 and the switch 538. When the battery pack 550 contains batteries with a charge and the switch 538 is switched on, the battery pack 550 supplies electricity to the artificial plant display through the fixture 542.

In various embodiments, each plug end 116 may include a self-contained fiber optic light source such that the spray may be relocated to a different type of base unit and such that replacement of the fiber optic light source requires, at most, replacement of the individual plant spray. In such embodiments the lens is disposed at an intermediate position in the plug end and a light emitting diode or other low heat light source is positioned at the end of the plug 116. Preferably the end of the plug 116 on which the light emitting diode is mount is highly thermally conductive so that heat is readily transmitted to a base unit structure disposed underneath the plug 116. Preferably the walls of the plug 116 are comprised of a material that has substantially lower thermal conductivity so as to prevent conduction of heat upwards toward the plant display.

FIG. 19 shows an alternative embodiment which can include the features and functionalities described above. This embodiment is adapted to be disposed within a pot or other suitable container. The base disc 602 includes apertures through which the spray plugs extend so as to insert into individual receptacles 602. The receptacles 602 each have heat sink fins disposed on their bottom surfaces. The plugs ends and the receptacles can otherwise be configured consistent with the foregoing teachings. This embodiment advantageously reduces the weight and cost of the base unit while preserving all of the aforementioned functionality.

A number of embodiments have been described. It is contemplated that a plurality of the aforementioned specific features can be combined into a single device, as will be understood by those skilled in the art. Nevertheless, it will be understood that various modifications may be made without departing from the spirit and scope of this disclosure. Accordingly, other embodiments are within the scope of the following claims.

What is claimed is:

1. An illuminable artificial plant display comprising:
a plurality of individual plant sprays, each spray comprising:
a distal end resembling plant life and including a plurality of light emitting diode bulbs and fiber optic strands,
a proximal end terminating in a plug that includes a plurality of electrical contacts and an optical lens that orthogonally intersects an axis extending from the distal end to the proximal end, the plurality of fiber optic strands being optically coupled to the lens and the light emitting diodes electrically being coupled to the electrical contacts;
an alignment means to ensure that the spray is positioned in one or more predetermined orientations relative to the base unit; and
a substantially water resistant seal to substantially inhibit water intrusion into the base unit during normal exposure to outdoor weather conditions when the plug is in an installed position relative to the base unit; and
a base unit comprising:
a top portion having a plurality of apertures to receive the plugs;
a plurality of receptacles positioned below respective ones of the apertures, the receptacles being configured to releasably receive the plugs and having a light emitting diode positioned at a bottom end of the receptacle such that the diode is aligned with the optical lens, the receptacle further including a vertically extending wall having at least one electrical contact that engages a cooperating electrical contact on the coupling when the coupling is in an installed position;
the receptacle having walls comprised of a material that has low thermal conductivity and wherein the receptacle has a bottom portion comprising a structure having a high thermal conductivity; and
wherein the light emitting diode portion is mounted to said structure such that heat is conducted away from the light emitting diode.

2. The lighted artificial plant display of claim 1, further comprising an ornamental housing that is rigidly coupled to the base unit such that a substantial majority of the base unit is spaced apart from the housing, thereby forming a convection channel around the base unit that promotes heat transfer from the base unit while substantially minimizing heat transfer to the housing.

3. An artificial plant display comprising:
a plurality of individual plant sprays, each spray comprising:
a distal end resembling plant life and including a plurality of light emitting diode bulbs and
a plurality of fiber optic strands; and
a proximal end terminating in a coupling, the coupling including a plurality of electrical contacts and an optical lens that orthogonally intersects an axis extending from the distal end to the proximal end, the lens being optically coupled to the plurality of fiber optic strands and the light emitting diodes being electrically coupled to the electrical contacts; and
a base unit configured to receive said couplings, the base unit further comprising:
a plurality of apertures to receive the couplings; and
a plurality of receptacles positioned below respective ones of the apertures, the receptacles being configured to releasably receive the coupling and having a light emitting diode positioned at a bottom end of the receptacle such that the diode is aligned with the proximal end of the plurality of fiber optic strands when the coupling is in an installed position;
wherein the lens is located between and substantially aligned with the light emitting diode in the receptacle and proximal ends of the fiber optic strands in the coupling when the coupling is in an installed position.

4. The artificial plant display of claim 3 wherein the lens is readily removable by a user.

5. The artificial plant display of claim 3 wherein each individual plant spray further comprises an alignment means to ensure that the spray is positioned in one or more predetermined orientations relative to the base unit.

6. The artificial plant display of claim 3 wherein the receptacle further includes a vertically extending wall having at least one electrical contact that engages a cooperating electrical contact on the coupling when the coupling is in an installed position.

7. The artificial plant display of claim 3 wherein the base unit further comprises a top portion and a bottom portion that are sealingly mated in a substantially waterproof manner

8. The artificial plant display of claim 3 wherein the receptacles have walls comprised of a material that has low thermal conductivity and wherein the receptacles have a bottom portion comprising a structure having a high thermal conductivity and wherein the light emitting diode portion is mounted to said structure such that heat is conducted away from the light emitting diode.

9. The artificial plant display of claim 8 wherein the structure comprises a substantially planar metal structure that has high thermal conductivity.

10. The artificial plant display of claim 8, wherein the base unit further includes a plurality of fins to promote heat transfer away from the base unit.

11. The artificial plant display of claim 3 wherein each individual plant spray further comprises a substantially waterproof seal to substantially inhibit water intrusion into the base unit during normal exposure to outdoor weather conditions when the coupling is in an installed position relative to the base unit.

12. The artificial plant display of claim 3 wherein the artificial plant display further comprises an ornamental housing that is rigidly coupled to the base unit such that a substantial majority of the base unit is spaced apart from the housing, thereby forming a convection channel around the base unit that promotes heat transfer from the base unit while substantially minimizing heat transfer to the housing.

13. The artificial plant display of claim 3 wherein the individual plant sprays are interchangeable with each other within a single receptacle.

14. The artificial plant display of claim 3, wherein in the base unit comprises a battery and a rectifier.

15. An artificial plant display comprising:
one or more plant sprays, each spray comprising:
a distal end resembling plant life and including a plurality of fiber optic strands, and
a proximal end terminating in a coupling, the coupling including an optical lens that orthogonally intersects an axis extending from the distal end to the proximal end, the lens being optically coupled to the plurality of fiber optic strands; and
a base unit configured to receive said couplings, the base unit further comprising:
one or more apertures to receive the couplings; and
one or more receptacles positioned below respective ones of the apertures, the receptacles being configured to releasably receive the coupling and having a light emitting diode positioned at a bottom end of the receptacle such that the diode is aligned with the proximal end of the plurality of fiber optic strands when the coupling is in an installed position;
wherein the lens is located between and substantially aligned with the light emitting diode in the receptacle and proximal ends of the fiber optic strands in the coupling when the coupling is in an installed position.

16. The artificial plant display of claim 15 wherein the lens is readily removable by a user.

17. The artificial plant display of claim 15 wherein each individual plant spray further comprises an alignment means to ensure that the spray is positioned in one or more predetermined orientations relative to the base unit.

19. The artificial plant display of claim 15 wherein the receptacles have walls comprised of a material that has low thermal conductivity and wherein the receptacles have a bottom portion comprising a structure having a high thermal conductivity and wherein the light emitting diode portion is mounted to said structure such that heat is conducted away from the light emitting diode.

20. The artificial plant display of claim 19, wherein the base unit further includes a plurality of fins to promote heat transfer away from the base unit.

21. The artificial plant display of claim 15, wherein in the base unit comprises a battery and a rectifier.
